(19) United States
(12) Patent Application Publication
(10) Pub. No.: US 2014/0365042 A1
(43) Pub. Date: Dec. 11, 2014

(54) Method and System for Aircraft Speed Control

(71) Applicant: The Boeing Company, Chicago, IL (US)

(72) Inventor: Luis Pedro D' Alto, Madrid (ES)

(21) Appl. No.: 14/297,002

(22) Filed: Jun. 5, 2014

(30) Foreign Application Priority Data
Jun. 6, 2013 (EP) 13382217.1

(51) Int. Cl. B64C 19/00

(52) U.S. Cl. CPC B64C 19/00
USPC 701/12

(57) ABSTRACT

The invention relates to methods and systems for controlling the speed of an aircraft. The methods and systems disclosed herein are particularly advantageous for unmanned aerial vehicles. A system may include an outer-loop controller, wherein the outer-loop controller is arranged to receive one or more target flight variables and to output a nominal target pitch; an inner-loop controller arranged to receive a target pitch and output a control signal for controlling at least one aircraft control device; and a saturation module arranged to receive a nominal target pitch and to output a target pitch for the inner-loop controller, wherein the nominal target pitch is limited between an upper bound and a lower bound by the saturation module to generate the target pitch.

This application claims the benefit of priority of European Patent Application Serial No. EP13382217.1, filed Jun. 6, 2013, entitled “METHOD AND SYSTEM FOR AIRCRAFT SPEED CONTROL”, which is incorporated herein by reference.

### BACKGROUND INFORMATION

1. Field

The invention relates to methods and systems for controlling the speed of an aircraft. The methods and systems disclosed herein are particularly advantageous for unmanned aerial vehicles.

2. Background

For correct operation of an aircraft, its airspeed must be held between upper and lower limits. Above the upper limit, the airspeed of an aircraft may cause structural damage. Below the lower limit, the airspeed of an aircraft may be insufficient and the aircraft may stall. Limits imposed on aircraft typically incorporate some sort of safety factor and do not therefore correspond exactly to the speed at which structural damage or stall may occur.

Conventional systems for ensuring that aircraft operate within these limits involve manipulating either the inputs or the outputs of controllers for controlling the control surfaces or engines of the aircraft. Such manipulation involves complex “limit prediction” methods for predicting when an airspeed limit will be broken and/or “limit avoidance” methods for determining a change in the inputs or outputs of the controllers.

Accordingly, it would be advantageous to have a method and apparatus that takes into account one or more of the issues discussed above, as well as possibly other issues.

### SUMMARY

The invention provides simpler and more reliable methods and systems for ensuring the safe operation of aircraft.

According to a first aspect of the invention, there is provided a system for controlling the speed of an aircraft, comprising: at least one outer-loop controller, wherein the/each outer-loop controller is arranged to receive one or more target flight variables and to output a nominal target pitch; an inner-loop controller arranged to receive a target pitch and output a control signal for controlling at least one aircraft control device; and a saturation module arranged to receive a nominal target pitch and to output a target pitch for the inner-loop controller, wherein the nominal target pitch is limited between an upper bound and a lower bound by the saturation module to generate the target pitch.

According to a second aspect of the invention, there is provided a method for controlling the pitch of an aircraft, comprising: defining an upper bound for a target pitch; defining a lower bound for a target pitch; receiving one or more target flight variables; calculating a nominal target pitch from the one or more target variables; applying an upper bound and a lower bound to limit the nominal target pitch to generate a target pitch; and calculating a control signal for controlling at least one aircraft control device from the target pitch.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives, and advantages thereof, will best be understood by reference to the following detailed description of advantageous embodiments of the present disclosure when read in conjunction with the accompanying drawings, wherein:

FIG. 1 is an illustration of a block diagram of a system for controlling the pitch of an aircraft in accordance with an advantageous embodiment;

FIG. 2 is an illustration of a block diagram of a further system for controlling the pitch of an aircraft in accordance with an advantageous embodiment;

FIG. 3 is an illustration of a flowchart of a process for controlling the pitch of an aircraft in accordance with an advantageous embodiment; and

FIG. 4 is an illustration of a data processing system in accordance with an advantageous embodiment.

### DETAILED DESCRIPTION

Aircraft can vary in configuration, for example by movement of flaps or slats. For each configuration, an aircraft has an associated maximum airspeed that defines the greatest speed, relative to the body of air through which it is travelling, at which the aircraft can travel safely—for example, higher speeds may cause structural damage and/or result in adverse aerodynamic effects such as buffeting, or hinder the aircraft from maneuvering effectively. The phrase maximum airspeed for the aircraft as used hereinafter means the maximum airspeed corresponding to the configuration of the aircraft at the relevant time. For safety reasons, it is often preferred to define a maximum permitted airspeed as being less than the true maximum airspeed by a suitable safety factor.

For each configuration, an aircraft will also have an associated minimum maneuvering airspeed that defines the lowest speed, relative to the body of air through which the aircraft is travelling, at which the aircraft can maneuver safely without stalling. The phrase minimum maneuvering airspeed for the aircraft as used hereinafter means the minimum maneuvering airspeed corresponding to the configuration of the aircraft at the relevant time. For safety reasons, it is often preferred to define a minimum permitted airspeed as being higher than the true minimum maneuvering airspeed by a suitable safety factor.

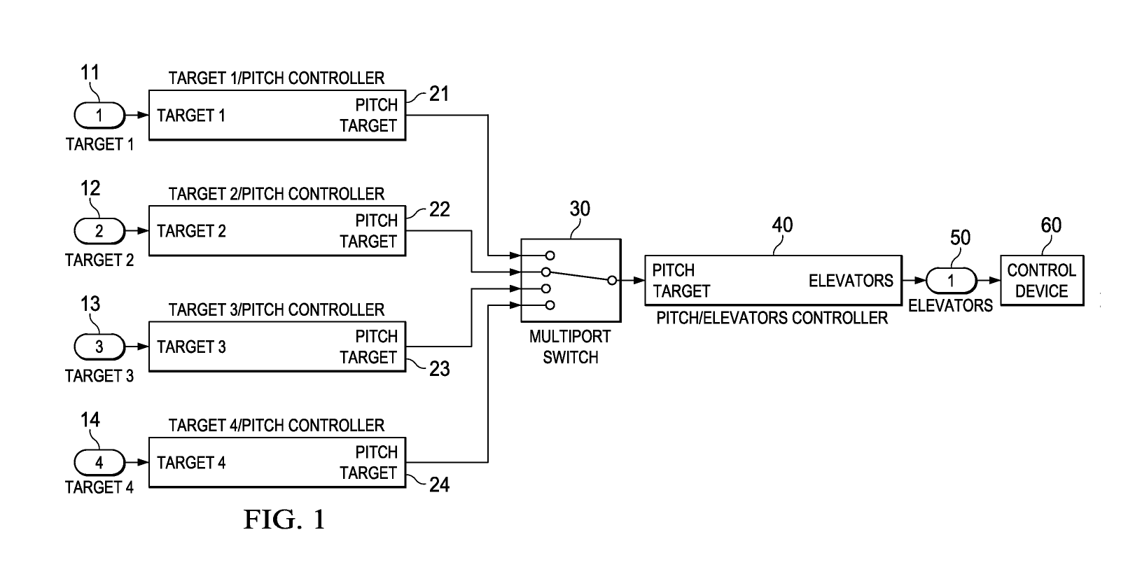

As shown in FIG. 1, a system for controlling the pitch of an aircraft may include a number of outer-loop controllers 21, 22, 23, 24 and an inner-loop controller 40. “A number”, as used herein with reference to items, means one or more items. For example, “a number of different considerations” means one or more different considerations.

The inner-loop controller 40 receives a pitch target and calculates how to manipulate one or more control devices 60 of the aircraft to achieve the target pitch. Preferably, the control device 60 is a movable control surface, such as an elevator. Control surfaces may include elevators, rudders, ailerons, flaps, and other surfaces.

The inner-loop controller 40 generates a control signal 50 (e.g. for controlling an elevator) based upon the pitch target provided by an outer-loop controller 21, 22, 23, 24. The control signal may control a control surface through a rate of change value, position value, force value, or other values. Other controllers, not shown, may receive control signal 50 for further operation of specific control machinery such as hydraulic or electric actuators.

Each outer-loop controller 21, 22, 23, 24 receives an input 11, 12, 13, 14. The input 11, 12, 13, 14 may be set by a pilot, or by a predetermined flight plan, and indicate the desired flight variables. Flight variables may include altitude, flight path angle, airspeed, vertical speed, and other flight variables that are desired to be achieved.

Each outer-loop controller 21, 22, 23, 24 calculates the pitch target to output to the inner-loop controller 40. A controller may calculate a value for one or more flight variables. Additionally a controller may calculate a value for specific time periods during flight. One or more of the outputs from the controllers may optionally be combined as a composite output.

A switch 30 selects which outer-loop controller 21, 22, 23, 24 instructs the inner-loop controller 40. Switch 30 may select an outer-loop controller based on other variables such as time, position, and flight variable.

Each outer-loop controller 21, 22, 23, 24 will be responsible for determining a target pitch for a particular phase of a flight plan. For example, outer-loop controller 21 may be responsible for controlling pitch during ascent, while outer-loop controller 22 may be responsible for controlling pitch during descent, etc.

For correct operation, the airspeed of an aircraft must be held between upper and lower limits. Above the upper limit, the airspeed of an aircraft may cause structural damage. Below the lower limit, the airspeed of an aircraft may be insufficient and the aircraft may stall. Limits imposed on aircraft typically incorporate some sort of safety factor and do not therefore correspond exactly to the speed at which structural damage or stall may occur.

The system for ensuring that aircraft operate within these limits may involve manipulating either the inputs 11, 12, 13, 14 to the control system, or the control signal 50 output by the inner-loop controller 40. Such manipulation may include complex “limit prediction” methods for predicting when an airspeed limit will be broken and/or “limit avoidance” methods for determining a change in the inputs 11, 12, 13, 14 and/or the control signal 50.

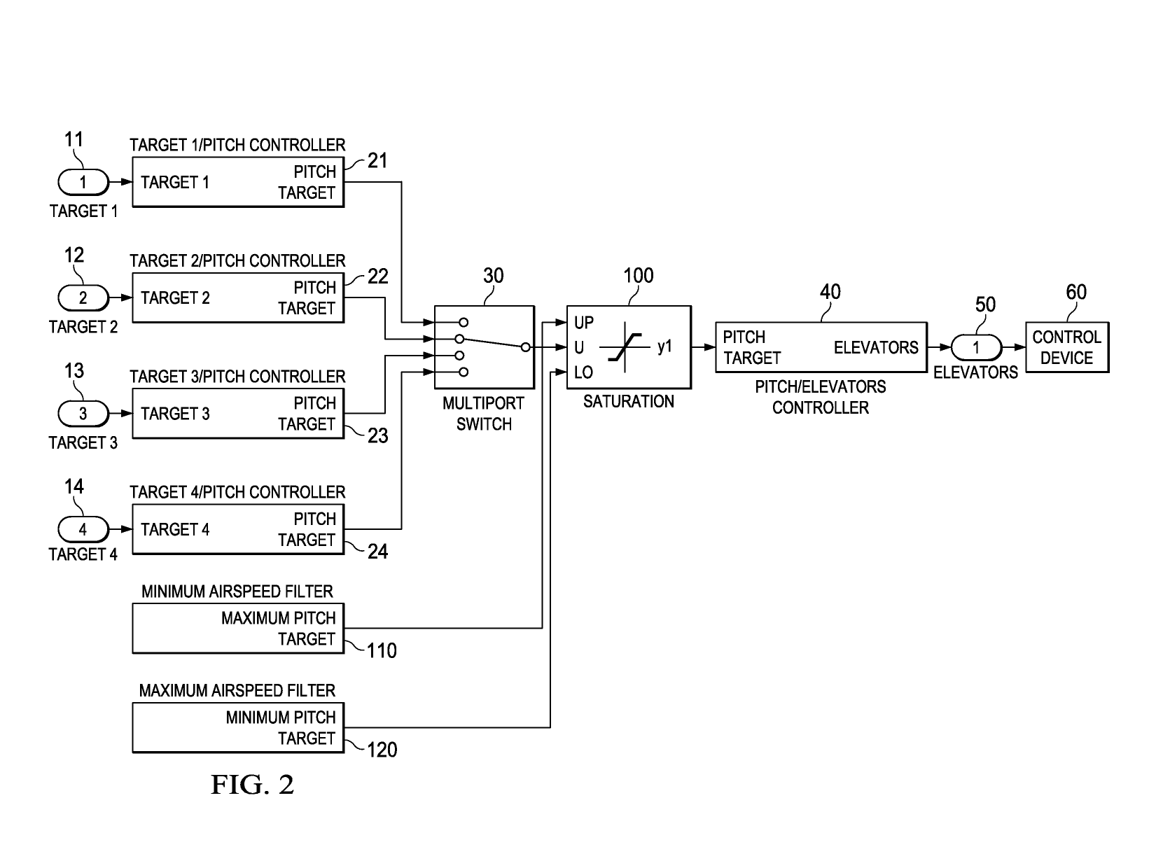

Turning now to FIG. 2, an illustration of a block diagram of a system for controlling the pitch of an aircraft is depicted in accordance with an advantageous embodiment. The system of FIG. 2 may be performed by a data processing system as further described herein. FIG. 2 further shows an embodiment of the invention in which safe operation of an aircraft may be achieved by limiting the pitch target output by each of the outer-loop controllers 21, 22, 23, 24.

Preferably, this limitation is achieved by the use of saturation module 100. Saturation model 100 comprises a module that limits the range of the input to the inner-loop controller 40. Saturation module 100 limits the range of the input such that it does not lie outside of a prescribed range. Saturation module 100 sets an upper limit and a lower limit. If a pitch target fed to saturation module 100 fits between the upper limit and the lower limit, the pitch target is not changed. If however, a pitch target exceeds the limit range of saturation module 100, the pitch target is chopped. Any pitch target that exceeds the upper limit, is limited to the value of the upper limit. Any pitch target that falls below the lower limit, is limited to the lower limit.

In one embodiment, the upper and lower limits of saturation module 100 are not static. The values of the upper and lower limits may change as part of a dynamic system. Saturation module 100 may receive inputs related to pitch angle and aircraft configuration. Optionally, saturation module 100 may also include inputs related to airspeed. The inputs of pitch angle, aircraft configuration, and airspeed may be used to reset upper and lower limits.

As with the embodiment of FIG. 1, the embodiment of FIG. 2 includes one or more outer-loop controllers 21, 22, 23, 24 and an inner-loop controller 40. When a plurality of outer-loop controllers 21, 22, 23, 24 are provided, a switch 30 may be provided to select the outer-loop controller 21, 22, 23, 24.

The system may be arranged such that the outer-loop controllers 21, 22, 23, 24 provide pitch targets to the inner-loop controller 40 via the saturation module 100.

Saturation module 100 may receive an input from the outer-loop controllers 21, 22, 23, 24, and provide an output of a pitch target to the input of inner-loop controller 40. When a switch 30 is provided, the saturation module may be located at the output of the switch 30, or a saturation module 100 may be located at the output of each outer-loop controller 21, 22, 23, 24.

The saturation module 100 may compare the received pitch target from the outer-loop controllers 21, 22, 23, 24 with an upper pitch bound and a lower pitch bound, and provide an output of a pitch target that is limited by the upper pitch bound and the lower pitch bound. The output to the elevators may be the angle of deflection for the elevator such as an elevator deflection target. The output may be sent to a further controller for other systems such the actuator controller for an electric motor or hydraulic system.

If the received pitch target from the outer-loop controllers 21, 22, 23, 24 exceeds the upper pitch bound then the saturation module 100 will output a pitch target to the inner-loop controller 40 equal to the upper bound.

If the received pitch target from the outer-loop controllers 21, 22, 23, 24 is below the lower pitch bound then the saturation module 100 will output to the inner-loop controller 40 a pitch target equal to the lower bound.

If the received pitch target from the outer-loop controllers 21, 22, 23, 24 is between the upper pitch bound and the lower pitch bound then the saturation module 100 will output to the inner-loop controller 40 a pitch target equal to that received from the outer-loop controllers 21, 22, 23, 24.

The upper pitch bound and the lower pitch bound may also be calculated using one or more airspeed filters. Minimum airspeed filter 110 and maximum airspeed filter 120 may include a controller function. Alternatively, minimum airspeed filter 110 and maximum airspeed filter 120 may function as a low pass filter and high pass filter. The low pass filter and high pass filter may also be dynamic in that each can be adjusted based on present conditions and based on a history. Thus, the range of frequency that may be passed through minimum airspeed filter 110 and maximum airspeed filter 120 be adjusted based on conditions. Where minimum airspeed filter 110 and maximum airspeed filter 120 are used to set an upper and lower boundary, saturation module 100 may not be used to set the dynamic limits.

In one embodiment, minimum airspeed filter 110 and maximum airspeed filter 120 operate with conditions in which an airspeed is set or defined. Thus one preferred embodiment is that power adjustment does not enter the system as a control input. Power, however, may be manually adjusted. Minimum airspeed filter 110 and maximum airspeed filter 120 may use pitch settings as a proxy for airspeed. Thus minimum airspeed filter 110 sets a maximum pitch target, and maximum airspeed filter 120 sets a minimum pitch target.

Specifically, the upper pitch bound may be calculated using a minimum airspeed filter 110, and the lower pitch bound may be calculated using a maximum airspeed filter 120.

Preferably, the maximum airspeed filter 120 may receive an input signal representative of the difference between the current airspeed and the maximum permitted airspeed, and provide an output signal that is a function of the input signal.

Preferably, the minimum airspeed filter 110 may receive an input signal representative of the difference between the current airspeed and the minimum permitted airspeed, and provide an output signal that is a function of the input signal.

In preferable embodiments, the airspeed filters 110, 120 apply a function comprising one or more of: a term proportional to the input signal; and a term proportional to the derivative of the input signal.

For example, the function may be a sum or a weighted sum of the terms. Other functions may also be applied.

The airspeed filters 110, 120 described above comprise proportional-derivative filters. However, this is not essential. Any form of linear and non-linear filter can be used. However, linear filters are generally preferred. Most preferably, the airspeed filters 110, 120 may comprise linear filters with no integral effect. For example, the airspeed filters 110, 120 may comprise “lead-lag” controllers having no poles at the origin.

Any form of controller may be suitable for use as an outer-loop controller 21, 22, 23, 24. In preferred embodiments, one or more of the outer-loop controllers 21, 22, 23, 24 may comprise a PID controller. As is known in the art, correct operation of PID controllers can be hindered by actuator saturation whereby the magnitude of a control signal from a controller exceeds that achievable by an actuator. This could occur in some embodiments because the ability of the outer-loop controllers 21, 22, 23, 24 to control the aircraft pitch is hindered by the one or more airspeed filters. In other words, the nominal output of the outer-loop controllers 21, 22, 23, 24 may become unstable due to the indirect nature of their control over the aircraft.

A technique known as “wind-up compensation” may optionally be used to compensate for such saturation. Wind-up compensation is a technique in which the output of the integrator is limited to prevent the control signal from causing actuator saturation. Embodiments are therefore envisaged in which outer-loop controllers 21, 22, 23, 24 incorporate wind-up compensation.

The system of FIG. 2 may advantageously be used in unmanned vehicles. Further the system may be appropriate for fixed wing, unmanned vehicles. The system provides a generally simplified and robust control system compared to other systems, such as used with manned vehicles. For example, the quality of ride or guidance provided by the system may differ from the kind of control system typically provided for use with manned vehicles. Control in manned vehicles includes significant tuning in order to achieve a smooth quality of ride demanded by the flying public. The systems described herein advantageously avoid the tuning that is necessary for filters in manned vehicles. The system may advantageously be developed quickly and economically, compared to that used in manned aircraft, without the need for extensive tuning.

Further, the system of FIG. 2 is a generally preferred system for use in operation of cruise, ascent, or descent. The system is not typically used alone for landing operations.

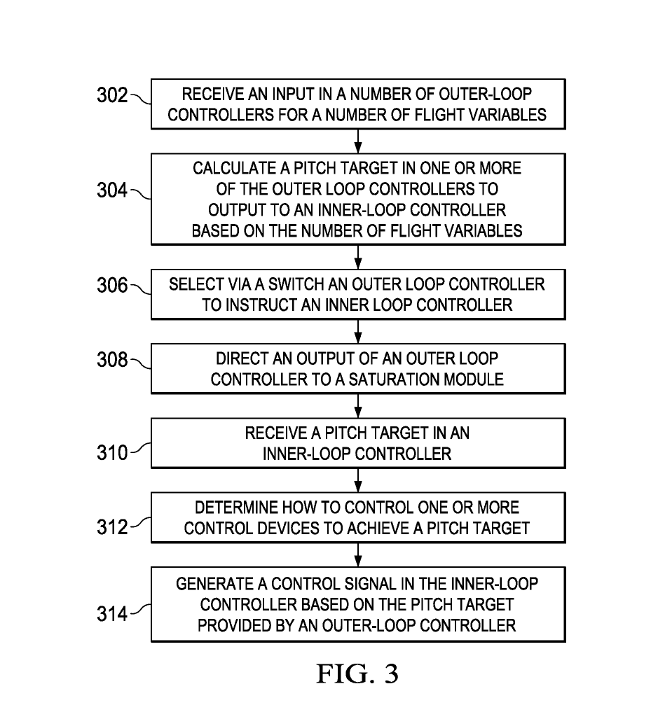

Turning now to FIG. 3, an illustration of a flowchart of a process for controlling the pitch of an aircraft is depicted in accordance with an advantageous embodiment. The process of FIG. 3 may be performed by data processing system as further described herein.

The process begins when a number of outer-loop controllers receive an input for a number of flight variables (operation 302).

In a further operation, the number of outer-loop controllers calculates a pitch target to output to an inner-loop controller based on the number of flight variables (operation 304).

In a further operation, a switch may select an outer loop controller to instruct an inner loop controller (operation 306). A switch may provide one or more controller outputs. Selection of a controller output may be based on criteria associated with the flight variables.

In a further operation, an output of an outer loop controller is directed to a saturation module from the switch (operation 308). The saturation module may provide for maximum and minimum levels of values that pass through the saturation module.

In a further operation, a pitch target is received in an inner-loop controller (operation 310). The pitch target may include values from the saturation module.

Still further, the inner loop controller may determine how to control one or more control devices to achieve a pitch target (operation 312). Inner loop controller may include software and programming suited to the aircraft, desired performance parameters, and the control devices disposed on the aircraft.

Still further, a control signal may be generated in the inner-loop controller based on the pitch target provided by an outer-loop controller (operation 314).

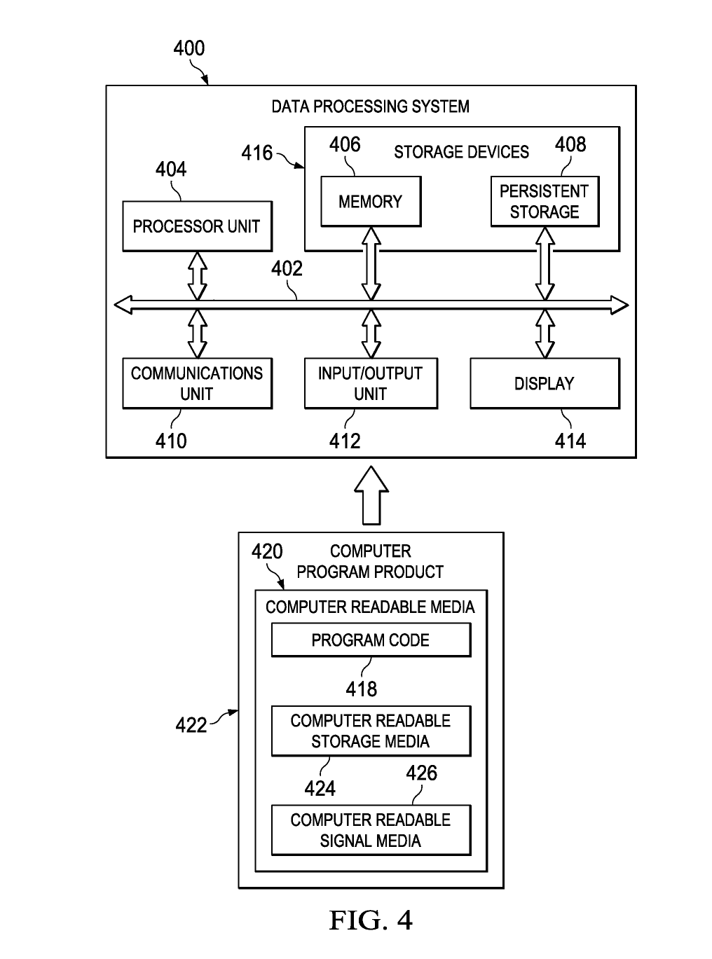

Turning now to FIG. 4, an illustration of a data processing system is depicted in accordance with an advantageous embodiment. In this example, data processing system 400 is an example of one implementation of a data processing device that may be used in connection with the systems in FIG. 1 and FIG. 2. Data processing system 400 also is an example of one implementation of data processing system 204 in FIG. 2.

In this illustrative example, data processing system 400 includes communications fabric 402. Communications fabric 402 provides communications between processor unit 404, memory 406, persistent storage 408, communications unit 410, input/output (I/O) unit 412, and display 414. Memory 406, persistent storage 408, communications unit 410, input/output (I/O) unit 412, and display 414 are examples of resources accessible by processor unit 404 via communications fabric 402.

Processor unit 404 serves to run instructions for software that may be loaded into memory 406. Processor unit 404 may be a number of processors, a multi-processor core, or some other type of processor, depending on the particular implementation. Further, processor unit 404 may be implemented using a number of heterogeneous processor systems in which a main processor is present with secondary processors on a single chip. As another advantageous example, processor unit 404 may be a symmetric multi-processor system containing multiple processors of the same type.

Memory 406 and persistent storage 408 are examples of storage devices 416. A storage device is any piece of hardware that is capable of storing information such as, for example, without limitation, data, program code in functional form, and/or other suitable information either on a temporary basis and/or a permanent basis. Storage devices 416 may also be referred to as computer readable storage devices in these examples. Memory 406, in these examples, may be, for example, a random access memory or any other suitable volatile or non-volatile storage device. Persistent storage 408 may take various forms, depending on the particular implementation.

For example, persistent storage 408 may contain one or more components or devices. For example, persistent storage 408 may be a hard drive, a flash memory, a rewritable optical disk, a rewritable magnetic tape, or some combination of the above. The media used by persistent storage 408 also may be removable. For example, a removable hard drive may be used for persistent storage 408.

Communications unit 410, in these examples, provides for communications with other data processing systems or devices. In these examples, communications unit 410 is a network interface card. Communications unit 410 may provide communications through the use of either or both physical and wireless communications links.

Input/output unit 412 allows for input and output of data with other devices that may be connected to data processing system 400. For example, input/output unit 412 may provide a connection for user input through a keyboard, a mouse, and/or some other suitable input device. Further, input/output unit 412 may send output to a printer. Display 414 provides a mechanism to display information to a user.

Instructions for the operating system, applications, and/or programs may be located in storage devices 416, which are in communication with processor unit 404 through communications fabric 402. In these advantageous examples, the instructions are in a functional form on persistent storage 408. These instructions may be loaded into memory 406 for execution by processor unit 404. The processes of the different embodiments may be performed by processor unit 404 using computer-implemented instructions, which may be located in a memory, such as memory 406.

These instructions are referred to as program instructions, program code, computer usable program code, or computer readable program code that may be read and executed by a processor in processor unit 404. The program code in the different embodiments may be embodied on different physical or computer readable storage media, such as memory 406 or persistent storage 408.

Program code 418 is located in a functional form on computer readable media 420 that is selectively removable and may be loaded onto or transferred to data processing system 400 for execution by processor unit 404. Program code 418 and computer readable media 420 form computer program product 422 in these examples. In one example, computer readable media 420 may be computer readable storage media 424 or computer readable signal media 426.

Computer readable storage media 424 may include, for example, an optical or magnetic disk that is inserted or placed into a drive or other device that is part of persistent storage 408 for transfer onto a storage device, such as a hard drive, that is part of persistent storage 408. Computer readable storage media 424 also may take the form of a persistent storage, such as a hard drive, a thumb drive, or a flash memory, that is connected to data processing system 400. In some instances, computer readable storage media 424 may not be removable from data processing system 400.

In these examples, computer readable storage media 424 is a physical or tangible storage device used to store program code 418 rather than a medium that propagates or transmits program code 418. Computer readable storage media 424 is also referred to as a computer readable tangible storage device or a computer readable physical storage device. In other words, computer readable storage media 424 is a media that can be touched by a person.

Alternatively, program code 418 may be transferred to data processing system 400 using computer readable signal media 426. Computer readable signal media 426 may be, for example, a propagated data signal containing program code 418. For example, computer readable signal media 426 may be an electromagnetic signal, an optical signal, or any other suitable type of signal. These signals may be transmitted over communications links, such as wireless communications links, optical fiber cable, coaxial cable, a wire, or any other suitable type of communications link. In other words, the communications link or the connection may be physical or wireless in the illustrative examples.

In some advantageous embodiments, program code 418 may be downloaded over a network to persistent storage 408 from another device or data processing system through computer readable signal media 426 for use within data processing system 400. For instance, program code stored in a computer readable storage medium in a server data processing system may be downloaded over a network from the server to data processing system 400. The data processing system providing program code 418 may be a server computer, a client computer, or some other device capable of storing and transmitting program code 418.

The different components illustrated for data processing system 400 are not meant to provide architectural limitations to the manner in which different embodiments may be implemented. The different advantageous embodiments may be implemented in a data processing system including components in addition to and/or in place of those illustrated for data processing system 400. Other components shown in FIG. 4 can be varied from the illustrative examples shown. The different embodiments may be implemented using any hardware device or system capable of running program code. As one example, data processing system 400 may include organic components integrated with inorganic components and/or may be comprised entirely of organic components excluding a human being. For example, a storage device may be comprised of an organic semiconductor.

In another advantageous example, processor unit 404 may take the form of a hardware unit that has circuits that are manufactured or configured for a particular use. This type of hardware may perform operations without needing program code to be loaded into a memory from a storage device to be configured to perform the operations.

For example, when processor unit 404 takes the form of a hardware unit, processor unit 404 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 418 may be omitted, because the processes for the different embodiments are implemented in a hardware unit.

In still another illustrative example, processor unit 404 may be implemented using a combination of processors found in computers and hardware units. Processor unit 404 may have a number of hardware units and a number of processors that are configured to run program code 418. With this depicted example, some of the processes may be implemented in the number of hardware units, while other processes may be implemented in the number of processors.

In another example, a bus system may be used to implement communications fabric 402 and may be comprised of one or more buses, such as a system bus or an input/output bus. Of course, the bus system may be implemented using any suitable type of architecture that provides for a transfer of data between different components or devices attached to the bus system.

Additionally, communications unit 410 may include a number of devices that transmit data, receive data, or transmit and receive data. Communications unit 410 may be, for example, a modem or a network adapter, two network adapters, or some combination thereof. Further, a memory may be, for example, memory 406, or a cache, such as found in an interface and memory controller hub that may be present in communications fabric 402.

The description of the different advantageous embodiments has been presented for purposes of illustration and description and is not intended to be exhaustive or to limit the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A system for controlling a speed of an aircraft, comprising:
at least one outer-loop controller, wherein the at least one outer-loop controller is arranged to receive one or more target flight variables and to output a nominal target pitch;
an inner-loop controller arranged to receive a target pitch and output a control signal for controlling at least one aircraft control device; and
a saturation module arranged to receive a nominal target pitch and to output a target pitch for the inner-loop controller,
wherein the nominal target pitch is limited between an upper bound and a lower bound by the saturation module to generate the target pitch.

2. The system of claim 1, further comprising a plurality of outer-loop controllers and a switch configured to select a selected nominal target pitch from the nominal target pitch provided by each outer-loop controller, wherein the saturation module is configured to receive the selected nominal target pitch.

3. The system of claim 1, wherein the lower bound is calculated based on a difference between a current airspeed and a maximum permitted airspeed.

4. The system of claim 1, further comprising a maximum airspeed filter for calculating the lower bound.

5. The system of claim 4, wherein the maximum airspeed filter comprises a linear filter with no integral effect.

6. The system of claim 1, wherein the upper bound is calculated based on a difference between a current airspeed and a minimum permitted airspeed.

7. The system of claim 1, further comprising a minimum airspeed filter for calculating the upper bound.

8. The system of claim 7, wherein the minimum airspeed filter comprises a linear filter with no integral effect.

9. A method for controlling a pitch of an aircraft, comprising:
defining an upper bound for a target pitch;
defining a lower bound for a target pitch;
receiving one or more target flight variables;
calculating a nominal target pitch from the one or more target variables;
applying an upper bound and a lower bound to limit the nominal target pitch to generate a target pitch; and
calculating a control signal for controlling at least one aircraft control device from the target pitch.

10. The method of claim 9, further comprising:
calculating a plurality of nominal target pitches from the one or more target variables; and
selecting a selected nominal target pitch from the plurality of nominal target pitches,
wherein the step of applying an upper bound and a lower bound to limit the nominal target pitch to generate a target pitch comprises applying an upper bound and a lower bound to limit the selected nominal target pitch to generate a target pitch.

11. The method of claim 9, wherein defining a lower bound for a target pitch comprises calculating the lower bound based on a difference between a current airspeed and a maximum permitted airspeed.

12. The method of claim 9, further comprising calculating the lower bound using a maximum airspeed filter.

13. The method of claim 9, further comprising calculating the lower bound using a linear filter with no integral effect.

14. The method of claim 9, wherein defining an upper bound for a target pitch comprises calculating the upper bound based on a difference between a current airspeed and a minimum permitted airspeed.

15. The method of claim 9, further comprising calculating the upper bound using a minimum airspeed filter.

16. The method of claim 9, further comprising calculating the upper bound using a linear filter with no integral effect.

17. A computer program product comprising:
a computer readable storage medium;
program code, stored on the computer readable storage medium, for defining an upper bound for a target pitch;
program code, stored on the computer readable storage medium, for defining a lower bound for a target pitch;
program code, stored on the computer readable storage medium, for receiving one or more target flight variables;
program code, stored on the computer readable storage medium, for calculating a nominal target pitch from the one or more target variables;
program code, stored on the computer readable storage medium, for applying an upper bound and a lower bound to limit the nominal target pitch to generate a target pitch; and
program code, stored on the computer readable storage medium, for calculating a control signal for controlling at least one aircraft control device from the target pitch.

18. The computer program product of claim 17, further comprising:
program code, stored on the computer readable storage medium, for calculating a plurality of nominal target pitches from the one or more target variables; and
program code, stored on the computer readable storage medium, for selecting a selected nominal target pitch from the plurality of nominal target pitches,
wherein applying an upper bound and a lower bound to limit the nominal target pitch to generate a target pitch comprises applying an upper bound and a lower bound to limit the selected nominal target pitch to generate a target pitch.

19. The computer program product of claim 17, further comprising: program code, stored on the computer readable storage medium, for calculating the lower bound using a linear filter with no integral effect.

20. The computer program product of claim 17, further comprising: program code, stored on the computer readable storage medium, for calculating the upper bound using a linear filter with no integral effect.
